(19) United States
(12) Patent Application Publication
(10) Pub. No.: US 2007/0184184 A1
(43) Pub. Date: Aug. 9, 2007

(54) Production of capsule shells and capsules

(76) Inventors: Linda Green, Orpington (GB); Adrian Mark Harrison, Maidstone (GB); Terence William Daniel Blaney, Goudhurst (GB); Marshall Whiteman, Ditton (GB); Martin David Hallett, Gravesend (GB)

Correspondence Address: Robert C Klinger;Jackson Walker, Suite 600, 2435 N Central Expressway, Richardson, TX, 75044, US

(21) Appl. No.: 10/562,997

(22) PCT Filed: Jun. 25, 2004
(86) PCT No.: PCT/GB04/02742

§ 371 Date: Aug. 7, 2006

(30) Foreign Application Priority Data
Jun. 25, 2003 (GB) 0314832.7

(51) Int. Cl. B05D 3/00

(52) U.S. Cl. 427/189

(57) ABSTRACT

A method for the production of a capsule shell comprises preparing the capsule shell by electrostatic powder deposition. A plurality of capsule shells may be produced by a process comprising electrostatically applying a powder coating material to a plurality of shaped substrates, treating the powder to form a continuous coating layer on each of the shaped substrates, and removing the shaped coating layers from the substrate to provide hollow capsule shells. An apparatus for the production of a capsule shell includes a substrate, a source of charged powder material and a voltage source for applying a bias voltage between the source of powder material and the substrate to generate an electric field therebetween such that powder material is applied to the substrate.

This invention relates to the production of capsule shells and capsules, more especially, but not exclusively, for use in the fields of pharmaceuticals and foods or food supplements.

The mass production of medicines, food supplements and other compounds in predefined doses has become an important part of the health care and other industries. Many of these doses are provided inside a hard or soft gelatin or cellulose capsule. Such a capsule may be easier to administer to a patient when compared to tablets, and the capsules may be readily produced by a mass production manufacturing facility. Capsules are also more easily transported by patients than are bulk liquids, since only the required number of doses are needed. Moreover, in comparison with compressed solid tablets or bulk liquid preparations, incorporation of an active ingredient in a capsule can permit more accurate delivery of a unit dose, an advantage which becomes especially important when relatively small amounts of the active ingredient must be delivered.

Most conventional capsule-making machines employ pin bars consisting of an elongated base and a plurality of depending metal pins. A lubricant grease, tetrafluoro-ethylene polymer or other material for easy release of the dried capsule shells is coated onto the pins and the pins are then dipped into a solution of the capsule material which adheres to and gels on the pins and is subsequently dried and hardened to form capsule shell halves. The hardened shell halves are then removed and cut to size, and after filling are subsequently fitted together.

Traditionally, mammalian gelatin has been the material of choice for producing the capsule envelope for both soft and hard-shell capsules. Although gelatin is useful for its rapid gelling ability, excellent film-forming properties and ability to impart oxygen impermeability, it has disadvantages, for example its high cost, limited availability and, at times, variation in properties between batches.

A number of patent specifications, for example U.S. Pat. No. 6,375,981 and U.S. Pat. No. 6,337,045, describe the use of water-soluble cellulose ethers or modified starch compositions for capsule formation. Cellulose-based capsules are typically manufactured by dipping hot pins in a cold, aqueous cellulose ether coating solution. Cellulose capsules have several advantages over conventional gelatin capsules, including resistance to microorganisms and greater stability under extreme humidity conditions, but there have been difficulties in manufacturing cellulose capsules in quantity with sufficient uniformity to be suitable for filling in modern high-speed filling machines, although hydroxypropyl methylcellulose capsules have been successfully marketed in recent years. It remains the case, however, that cellulose-based capsules are generally difficult to remove from the pins without loss of integrity of the cellulose film, and haze at their inner surfaces can be a problem.

Moreover, all manufacturing methods for capsules, whether gelatin or cellulose based, are complicated, and it is necessary to trim the capsules to size, which involves additional expense.

The present invention provides a method for the production of a capsule shell, wherein the capsule shell is prepared by electrostatic powder deposition.

Unlike the methods of the prior art, the method of the present invention is not a wet process and no drying step is required. Moreover, it is possible to apply the capsule material onto the substrate pins more accurately, so that the trimming step can be dispensed with. The method of the present invention also provides the opportunity for modification of the capsule material, which may, for example, be made water-soluble, acid-soluble or insoluble but permeable, as required, and an enteric coating may be contemplated.

The electrostatic application of powder material to a substrate is known. Methods have already been developed in the fields of electrophotography and electrography and examples of suitable methods are described, for example, in Electrophotography and Development Physics, Revised Second Edition, by L. B. Schein, published by Laplacian Press, Morgan Hill Calif. The electrostatic application of powder material to a solid dosage form is also known, for example from WO 92/14451, WO 96/35413, WO 96/35516 and WO 98/20861. These disclose, for example, coating of tablets and tablet cores and coating of conventional capsules, but there is no disclosure of the production of capsules by this method.

The present invention also provides a method for the production of a capsule wherein a capsule shell prepared by electrostatic powder deposition is filled and capped to provide a finished capsule.

In the method of the present invention, preferably powder is deposited electrostatically on a shaped substrate, and then treated to form a continuous layer on the substrate, for example by IR and/or convection heating, and the coating layer is removed to provide a hollow capsule shell. Subsequently, the capsule itself is assembled, generally from two such capsule shells, which may conveniently be referred to as capsule body and capsule cap. Before assembly the capsule body is filled, for example with liquid, powder or other solid material, and the cap fitted to the body. A capsule body and its capsule cap may be, but are not necessarily, of the same size and shape. However, a capsule may also be assembled using a capsule shell (capsule body) prepared by the method of the invention, which is provided with a cap by some other means.

A shaped substrate may be, for example, in the shape of a rod, for example about 5 mm in diameter, more especially for the production of conventionally shaped pharmaceutical capsules, but the capsules may be a different shape suitable for their mode of use, and appropriately shaped moulds should be used as substrates.

More especially, a substrate may be a metal substrate, for example steel; a metal support provides an excellent substrate for electrostatic deposition because of its high conductivity.

Preferably the substrate(s) is (are) treated with a releasing agent prior to application of the powder coating material. Releasing agents are known in the literature; in general, such materials provide lubrication for release but should not penetrate the coat during fusion. The use of an oil, paraffin or talc, for example, should be considered. Other releasing agents include PTFE, heavy paraffin liquid, polyethylene glycol, e.g. PEG 300.

The present invention also provides a method for the production of a capsule, which comprises the electrostatic application of a powder coating material to a shaped substrate, treating the powder to form a capsule shell, removing the capsule shell from the substrate, filling the capsule shell and assembling a capsule from the filled shell and a further such shell prepared in the same manner.

The present invention further provides a method for the production of capsule shells or capsules, which comprises electrostatically applying a powder coating material to a plurality of shaped substrates, treating the powder to form a continuous coating layer on each of the shaped substrates, and removing the shaped coating layers from the substrates to provide hollow capsule shells, constituting capsule bodies and capsule caps, and optionally filling the capsule bodies and assembling capsules from the filled capsule bodies and the capsule caps.

Suitable methods for assembling capsules are known in the literature. For example, the two halves may be pressed or squeezed together until they are frictionally locked. A particular assembling process with closing and ejection pins is for example, disclosed in U.S. Pat. No. 6,546,702. The capsules may also if desired be heat-sealed. An enteric seal is of course required for a capsule made from enteric material.

The filling material may be any material that can be apportioned into individual units, and is often a biologically active material, that is, a material that increases or decreases the rate of a process in a biological environment. The biologically active material may therefore be, for example, for use in agriculture or pest control (for example a fertiliser, pesticide, herbicide or repellent), or more especially is a material that is physiologically active, for example for use in medicine or nutrition (for example a vitamin, nutritional supplement, pre-measured food ingredient such as flavouring, confectionery). Other non-pharmaceutical capsules may be filled, for example, with material for use in bathing or washing, for example liquid soaps, foaming agents, perfumes, detergents, enzymes, bleach, or water or fabric softeners or rinse aids. Preferably, however, the capsules are for pharmaceutical use.

A coating layer formed on the substrate may be, for example, at least 20 μm in thickness, for example from 20 to 50 μm. Increasing the coating thickness will in general provide further capsule strength, and one or more layers may therefore be applied, each being fused before application of further powder, to provide a thickness of, for example, at least 0.2 mm. Alternatively, using a low charge to mass ratio and a large particle size powder, for example about 30 μm, may allow the production of a thicker capsule shell from a single layer.

Preferably the powder material is electrostatically charged and an electric field is present in the region of the shaped substrate to cause the powder material to be deposited on the shaped substrate. For example, the powder material may be electrostatically charged with a sign of one polarity, an electric potential of the same polarity may be maintained in the region of a source of the powder material and the substrate may be maintained at a lower, earth or opposite potential. For example, the powder material may be electrostatically charged positively, a positive potential may be maintained in the region of a source of the powder material and the substrate may be maintained at earth potential. The powder material may have a permanent or temporary net charge. Any suitable method may be used to charge the powder material. Advantageously, the electrostatic charge on the powder material is applied by triboelectric charging (as is common in conventional photocopying) or corona charging. The use of a charge-control agent encourages the particle to charge to a particular sign of charge and to a particular magnitude of charge.

The electric field is preferably provided by a bias voltage that is a steady DC voltage. Preferably, an alternating voltage, which is substantially higher than the DC voltage, is superimposed on the bias voltage. The alternating voltage preferably has a peak to peak value greater than, and more preferably more than twice, the peak value of the DC bias voltage. The DC bias voltage may be in the range of 100V to 2,000V and is preferably in the range of 200V to 1,200V. The alternating voltage may have a peak to peak value of the order of 5,000V and may have a frequency in the range of 1 to 15 kHz.

Achievement of good and even coating is facilitated if the spacing between the source of powder material and the substrate is relatively small, that is less than 10 mm.

Preferably the spacing is in the range of 0.3 mm to 5 mm and more preferably between 0.5 mm to 5 mm.

The method may include the steps of:

applying a bias voltage to generate an electric field between a source of the powder material and the substrate;

applying the electrostatically charged powder material to the substrate, the powder material being driven onto the substrate by the interaction of the electric field with the charged powder material and the presence of the charged powder material on the substrate serving to build up an electric charge on the substrate and thereby reduce the electric field generated by the bias voltage between the source of powder material and the substrate, and

continuing the application of the electrostatically charged powder material to the substrate until the electric field between the source of powder material and the substrate is so small that the driving of the powder material by the electric field onto the substrate is substantially terminated.

Using such a method promotes even coating of the substrate even when the spacing of some parts of the substrate from the source of powder material differs from the spacing of other parts. That is of particular advantage when the substrate is in the shape of a rod with a rounded end. Furthermore the method promotes even coating regardless of the rate at which powder is deposited on the substrate and may be employed when there is relative movement between the substrate and the source of powder material during deposition. In a case where the thickness of one layer of coating is not as great as the final thickness required, one or more other coating layers may be deposited and, if desired, the DC bias voltage increased for the deposition of the further layer(s).

An electrostatically conducting shield may be provided around part or all of the substrate. For example, in the case where the substrate is in the shape of a rod, the electrostatically conducting shield may be disposed closely around, and may or may not be spaced from, the rod at a distance from the end of the rod. The shield may be maintained at an electric potential more similar to that of the powder material than to that of the substrate. We have found that by providing an electrically conducting shield closely around the substrate and maintaining the shield at a potential more similar to that of the source of powder material than to that of the substrate, a physical and electrostatic barrier can be created and it becomes possible to confine the application of powder to the substrate and to coat a region of the substrate uniformly as far as a limit defined by the shield. Thus a well defined limit to the coating can be obtained. Where the substrate is a rod and the shield extends circumferentially around the rod, the limit to the coating may be defined at a predetermined axial distance from the end of rod.

The spacing of the shield from the substrate is preferably less than 1 mm and is preferably uniform. It may for example be in the range of 100 to 300 μm, eg 100 to 150 μm.

The electrically conducting shield may comprise an electrically conducting element covered wholly or partly by a layer of insulating material. The provision of a layer of insulating material, which is preferably thin, prevents accidental electrical contact being made between the substrate and the shield.

The potentials of the electrically conducting shield and the charge powder material are preferably of the same sign.

In the case where powder material is applied to a plurality of shaped substrates, a common shield may be provided around part or all of the substrates. For example, where the substrates are in the shapes of rods the shield may have a plurality of holes through each of which the end of a respective rod projects.

Selection of the physical arrangement to be employed for coating of the substrate is dependent upon the shape of the substrate to be coated. For example, it is possible to provide a plurality of separate sources of powder material to coat a single substrate and/or to provide sources of complex shapes and/or to provide electric fields of complex shapes. It is also possible to arrange for the source of powder material and/or the substrate to move during the application of the powder material. In the case where the substrate is a rod of circular cross-section, the source of powder material may be positioned at a radial spacing from the rod alongside the end portion of the rod and the rod may be rotated relative to the source of powder material. In such a case, if the rod is about 5 mm diameter, then the centre of the end of the rod may be about 2.5 mm further from the source of powder material than the circumferential portion of the rod. Such a difference in spacing need not, however, result in uneven coating, especially if application of the powder material is continued until the electric field between the source of material and the substrate is substantially cancelled. Another possibility is to provide the source of powder material on the longitudinal axis of the rod beyond the end of the rod.

Further details of suitable methods and apparatus are described in WO 92/14451, WO 96/35516, WO 01/43727, WO 02/49771, WO 03/061841 and GB 2393141 A, and in our co-pending applications GB 0314188.4, GB 0330171, GB 0407312.8 and GB 0409381.1, the texts and drawings of which are incorporated herein by reference.

The present invention also provides an apparatus for the production of a capsule shell, the apparatus including a substrate, a source of charged powder material and a voltage source for applying a bias voltage between the source of powder material and the substrate to generate an electric field therebetween such that powder material is applied to the substrate. Other optional features of the apparatus will be apparent from the description elsewhere of the method of the invention. The apparatus may be suitable for carrying out any of the methods described herein.

A plurality of substrates, in the form of a plurality of rotatable rods, may be provided and the rods may be arranged to be rotated by a common drive arrangement. The rods are preferably detachably mounted on respective mounting members that are arranged to be rotated by the common drive arrangement.

In selecting the powder composition to be used, properties to be considered include good wet and dry film strength, inertness to drugs or other materials to be encapsulated, and, where applicable, insolubility in cold water, oil and/or alcohol, solubility in hot water, temperature and/or pressure sealability, film clarity, film flexibility and/or edibility.

Powder coating materials that are treatable on the substrate to form a film coating and processes for their use are disclosed, for example, in WO 96/35413, WO 98/20861, WO 98/20863 and WO 01/57144, the texts and drawings of which are incorporated herein by reference. Advantageously the powder material is prepared by melt extrusion of the components of the powder material or by other methods producing particles comprising different component materials together in the particle.

Generally, the powder material includes a component which is fusible. Examples of suitable components include polymer binders (also referred to as resins), e.g. acrylic polymers, e.g. methacrylate polymers, for example an ammonio-methacrylate copolymer, for example those sold under the name Eudragit; polyvinylpyrrolidone and polyvinylpyrrolidone-vinyl acetate copolymers; polysaccharides, for example cellulose ethers and cellulose esters, e.g. hydroxypropyl cellulose, hydroxypropyl methylcellulose phthalate, hydroxypropyl methylcellulose and hydroxypropyl methylcellulose acetate succinate; phthalate derivatives of polymers. Others that should be mentioned include polyesters; polyurethanes; polyamides, for example nylons; polyureas; polysulphones; polyethers; polystyrene; biodegradable polymers, for example polycaprolactones, polyanhydrides, polylactides, polyglycolides, polyhydroxybutyrates and polyhydroxyvalerates; and also non-polymeric binders such as, for example, sugar alcohols, for example lactitol, sorbitol, xylitol, galactitol and maltitol; sugars, for example sucrose, dextrose, fructose, xylose and galactose; hydrophobic waxes and oils, for example vegetable oils and hydrogenated vegetable oils (saturated and unsaturated fatty acids), e.g. hydrogenated castor oil, carnauba wax, and bees wax; hydrophilic waxes; polyalkenes and polyalkene oxides; polyethylene glycol. Clearly there may be other suitable materials, and the above are given merely as examples. One or more fusible materials may be present. Preferred fusible materials generally function as a binder for other components in the powder. A polymer used may be one having release-rate controlling properties. Examples of such polymers include polymethacrylates, ethylcellulose, hydroxypropylmethyl-cellulose, methylcellulose, hydroxyethylcellulose, hydroxypropylcellulose, sodium carboxymethylcellulose, calcium carboxymethylcellulose, acrylic acid polymer, polyethylene glycol, polyethylene oxide, carrageenan, cellulose acetate, glyceryl monostearate, zein etc. Xylitol or other sugar alcohol may be added to the polymer binder, for example when the polymer binder is insoluble, to promote solubility. The fusible component may, if desired, comprise a polymer which is cured during the treatment, for example by heat curing or by irradiation with energy in the gamma, ultra violet or radio frequency bands.

In general the powder material should contain at least 30%, usually at least 35%, advantageously at least 80%, by weight of material that is fusible, and, for example, fusible material may constitute up to 95%, e.g. up to 85%, by weight of the powder. Wax, if present, is usually present in an amount of no more than 6%, especially no more than 3%, by weight, and especially in an amount of at least 1% by weight, for example 1 to 6%, especially 1 to 3%, by weight of the powder material.

After application the powder coating may be converted into a coherent film by heating, preferably by infra-red radiation, but other forms of electromagnetic radiation or convection heating may be used. Usually the change in the coating upon heating will simply be a physical change. The powder material may be heated to a temperature above its softening point, and then allowed to cool to a temperature below its Tg to form a continuous solid coating. It may, for example, be heated to a temperature of 150 to 250° C., for example for 1 to 5 minutes, e.g. 3 to 4 minutes. Preferably, the powder material is fusible at a pressure of less than 100 lb/sq inch, preferably at atmospheric pressure, at a temperature of less than 250° C. Alternatively, for example, if the powder coating comprises a polymer which is curable, it may be treated by convection and/or IR heating and/or by irradiation with energy in the gamma, ultra-violet or radio frequency bands, to form a continuous cross-linked polymer coating.

Selection of the fusible material(s) used will have regard, not only to the fusibility properties of the material, but also to other properties, for example its suitability to provide mechanical strength to the capsule and its triboelectric charging properties. Selection of the fusible component or components used may also be influenced by the end use. For example, it may be desirable to utilise a binder that has modified-release properties, for example methacrylate polymer, eg Eudragits, or a binder that is fast dissolving. When different fusible materials are used, they are preferably compatible so that they can fuse together.

The powder material may advantageously also include a plasticiser to provide appropriate rheological properties.

Examples of suitable plasticisers are ethyl citrate and polyethylene glycol and polyethylene glycol 6000. A plasticiser may be used with a resin in an amount, for example, of up to 50%, advantageously up to 30%, preferably up to 20%, by weight of the total of that resin and plasticiser, the amount depending inter alia on the particular plasticiser used. Plasticiser may be present, for example, in an amount of at least 2%, advantageously at least 5%, by weight based on the weight of the total powder material, and amounts of 2 to 30%, especially 5 to 20%, are preferred.

Preferably, the powder material includes a material having a charge-control function. That functionality may be incorporated into a polymer structure, as in the case of Eudragit resin mentioned above, and/or, for a faster rate of charging, may be provided by a separate charge-control additive. Examples of suitable charge-control agents are: metal salicylates, for example zinc salicylate, magnesium salicylate and calcium salicylate, quaternary ammonium salts, benzalkonium chloride, benzethonium chloride, trimethyl tetradecyl ammonium bromide (cetrimide), and cyclodextrins and their adducts. One or more charge-control agents may be used. Charge-control agent may be present, for example, in an amount of up to 10% by weight, especially at least 1% by weight, for example from 1-2% by weight, based on the total weight of the powder material.

The powder material may also include a flow aid present at the outer surface of the powder particles to reduce the cohesive and/or other forces between the particles. Suitable flow aids (which are also known as “surface additives”) are, for example, colloidal silica; metal oxides, e.g. fumed titanium dioxide, zinc oxide or alumina; metal stearates, e.g. zinc, magnesium or calcium stearate; talc; functional and non-functional waxes; and polymer beads, e.g. poly-methyl methacrylate beads, fluoropolymer beads and the like. Such materials may also enhance tribocharging. A mixture of flow aids, for example silica and titanium dioxide, should especially be mentioned. The powder material may contain, for example, 0 to 3% by weight, advantageously at least 0.1%, e.g. 0.2 to 2.5%, by weight of surface additive flow aid.

Often the powder material includes a colorant and/or an opacifier. Examples of suitable colorants and opacifiers include metal oxides, e.g. titanium dioxide, iron oxides; aluminium lakes, for example, indigo carmine, sunset yellow and tartrazine; approved food dyes; and natural pigments. A mixture of such materials may be used if desired. Opacifier preferably constitutes no more than 50%, especially no more than 40%, more especially no more than 30%, for example no more than 10%, by weight of the powder material, and may be used, for example, in an amount of at least 5% by weight of the powder. Titanium dioxide is an especially useful opacifier, providing white colour and having good hiding power and tinctorial strength. Colorant present with opacifier may, for example, constitute no more than 10%, preferably from 1 to 5%, by weight of the powder. If there is no opacifier, the colorant may be, for example, 1 to 15%, e.g. 2-15%, especially 2-10%, by weight of the powder. To achieve optimum colour, amounts of up to 40% by weight of colorant may be needed in some cases, for example if inorganic pigments, e.g. iron oxides, are used. However, the powder material usually contains, for example, from 0 to 25% by weight in total of colorant and/or opacifier.

The powder material may also include a dispersing agent, for example a lecithin. The dispersing component is preferably a surfactant which may be anionic, cationic or non-ionic, but may be another compound which would not usually be referred to as a “surfactant” but has a similar effect. The dispersing component may be a co-solvent. The dispersing component may be one or more of, for example, sodium lauryl sulphate, docusate sodium, Tweens (sorbitan fatty acid esters), polyoxamers and cetostearyl alcohol. Preferably, the powder material includes at lest 0.5%, e.g. at least 1%, for example from 2% to 5%, by weight of dispersing component, based on the weight of the powder material Most often it is about 10% by weight of the colorant plus opacifier content.

Where the capsule is to be taken orally, the powder coating material may further include one or more taste modifiers, for example aspartame, acesulfame k, cyclamates, saccharin, sugars and sugar alcohols or flavourings. Preferably there is no more than 5%, more preferably no more than 1%, of flavouring based on the weight of the powder material, but larger or smaller amounts may be appropriate, depending on the particular taste modifier used.

If desired, the powder material may further include a filler or diluent. Suitable fillers and diluents are essentially inert and low-cost materials with generally little effect on the colour or other properties of the powder, for example alginic acid, bentonite, calcium carbonate, kaolin, talc, magnesium aluminium silicate and magnesium carbonate.

The proportions in which the components of the powder material are mixed is largely dependent on the materials comprising the powder material and will be adjusted so that the desired properties of the powder material are obtained.

Examples of suitable proportions for a powder material would be:

Composition 1
83% by weight resin,
0-3% by weight wax,
11-14% by weight inorganic colorant,
1-2% by weight charge-control agent,
1% by weight flow aid (external additive).

Composition 2
90% by weight resin,
2% by weight wax,
5% by weight colorant,
2% by weight charge-control agent,
1% by weight flow aid (external additive).
   Composition 3
60% by weight resin having charge-control functionality
20% by weight xylitol
15% by weight opacifier
3.5% by weight colorant,
1.5% by weight dispersant

Composition 4
83% by weight resin
10% by weight opacifier
2% by weight colorant,
2% by weight dispersant
2% by weight charge-control agent
0.5% by weight disintegrant
0.5% by weight flow aid (external additive)

Preferably, the powder material has a glass transition temperature (Tg) in the range of 40° C. to 180° C., eg in the range 40 to 120° C. Advantageously, the material has a Tg in the range of 50° C. to 100° C. A preferred minimum Tg is 55° C., and a preferred maximum Tg is 70° C. Accordingly, more advantageously, the material has a Tg in the range of 55° C. to 70° C.

Where the capsule is to be taken orally, the powder material should of course be pharmaceutically acceptable.

Preferably, at least 50% by volume of the particles of the material have a particle size no more than 100 μm.

Advantageously, at least 50% by volume of the particles of the material have a particle size in the range of 5 μm to 40 μm. More advantageously, at least 50% by volume of the particles of the material have a particle size in the range of 10 to 25 μm.

Powder having a narrow range of particle size should especially be mentioned. Particle size distribution may be quoted, for example, in terms of the Geometric Standard Deviation (“GSD”) figures d₉₀/d₅₀ or d₅₀/d₁₀ where d₉₀ denotes the particle size at which 90% by volume of the particles are below this figure (and 10% are above), d₁₀ represents the particle size at which 10% by volume of the particles are below this figure (and 90% are above), and d₅₀ represents the mean particle size. Advantageously, the mean (d₅₀) is in the range of from 5 to 40 μm, for example from 10 to 25 μm. Preferably, d₉₀/d₅₀ is no more than 1.5, especially no more than 1.35, more especially no more than 1.32, for example in the range of from 1.2 to 1.5, especially 1.25 to 1.35, more especially 1.27 to 1.32, the particle sizes being measured, for example, by Coulter Counter. Thus, for example, the powder may have d₅₀=10 μm, d₉₀=13 μm, d₁₀=7 μm, so that d₉₀/d₅₀=1.3 and d₅₀/d₁₀=1.4.

Whilst it will often be desirable for the capsule shell to have a wall of uniform thickness, it may sometimes be desirable for the wall of the capsule shell to incorporate one or more apertures, or portions of reduced thickness. Such constructions may be useful, for example, to enhance or facilitate a range of drug delivery possibilities. As an example, if the capsule shell is insoluble, the drug will only be released via the aperture, resulting in a prolonged release profile. Other forms of modified release of a drug from the capsule may also be provided. Masking of one or more areas may be carried out, for example, by the process described in GB 2393141 A or by utilising regions of different electrical conductivity.

Accordingly, the surface of the substrate on which the powder is deposited may be formed generally of an electrically conducting material but may include at least one region formed of a material of reduced electrical conductivity. The material of reduced electrical conductivity is preferably an electrically insulating material. There may be reduced deposition of powder on the material of reduced electrical conductivity, resulting in a thinner region of the wall of the capsule shell, or there may be substantially no powder deposition on the material of reduced electrical conductivity, resulting in an aperture in the wall of the capsule shell.

The or each region of reduced electrical conductivity may conveniently be of generally circular shape and may be formed by an insert fixed in a recess in the substrate. For example an insert may be screwed into a threaded hole in the substrate.

As will be understood from the description above, the capsule shell may be formed with at least one aperture, for example by taking the steps described above.

Such methods may also be of applicability in other electrostatic coating processes, both using powder material and liquid material.

Accordingly, there is also provided a method of electrostatic coating a substrate to provide a coating having regions of different thicknesses and/or incorporating one or more apertures, wherein the substrate comprises regions of different electrical conductivity.

Features of the general invention described herein with reference to the production of a capsule shell, including the features mentioned in relation to coatings having regions of different thicknesses and/or incorporating one or more apertures, apply also to the above-mentioned other electrostatic processes.

Thus, for example, the surface of the substrate on which there is deposition is formed generally of an electrically conducting material but includes at least one region formed of a material of reduced electrical conductivity, for example an electrically insulating material, and there may, for example, be no deposition on the material of reduced electrical conductivity. The coating may, for example, be formed with at least one aperture. Use, for example, in coating a pharmaceutical substrate and use, for example, in the processes described in WO 92/14451, WO 96/35413, WO 98/20861 and WO 98/20863 and in our co-pending application GB 0318353 should especially be mentioned; the texts and drawings of these specifications are incorporated herein by reference.

By way of example of the production of capsule shells, an apparatus suitable for the application of powder material to a substrate to form a capsule shell will now be described with reference to the accompanying drawings, in which:

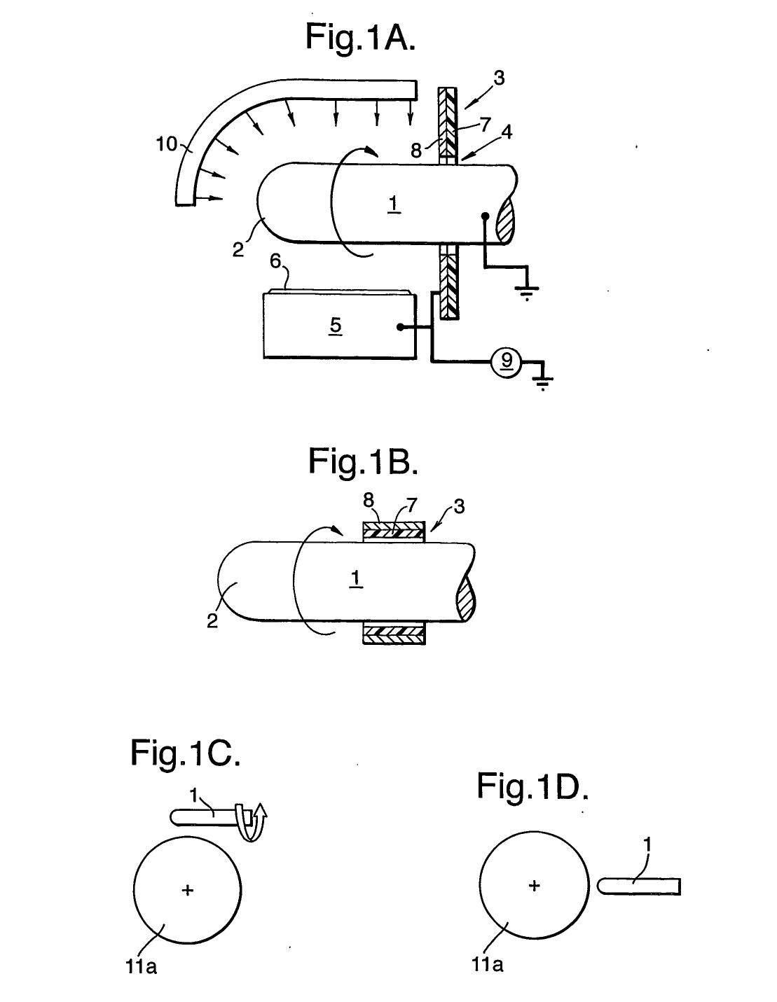

FIG. 1A is a schematic side view of the apparatus;

FIG. 1B is a schematic side view of a modified part of the apparatus;

FIG. 1C is a schematic side view showing a particular arrangement of a powder material source that may be employed in the apparatus of FIG. 1A or FIG. 1B;

FIG. 1D is a schematic side view showing another particular arrangement of a powder material source that may be employed in the apparatus of FIG. 1A or FIG. 1B;

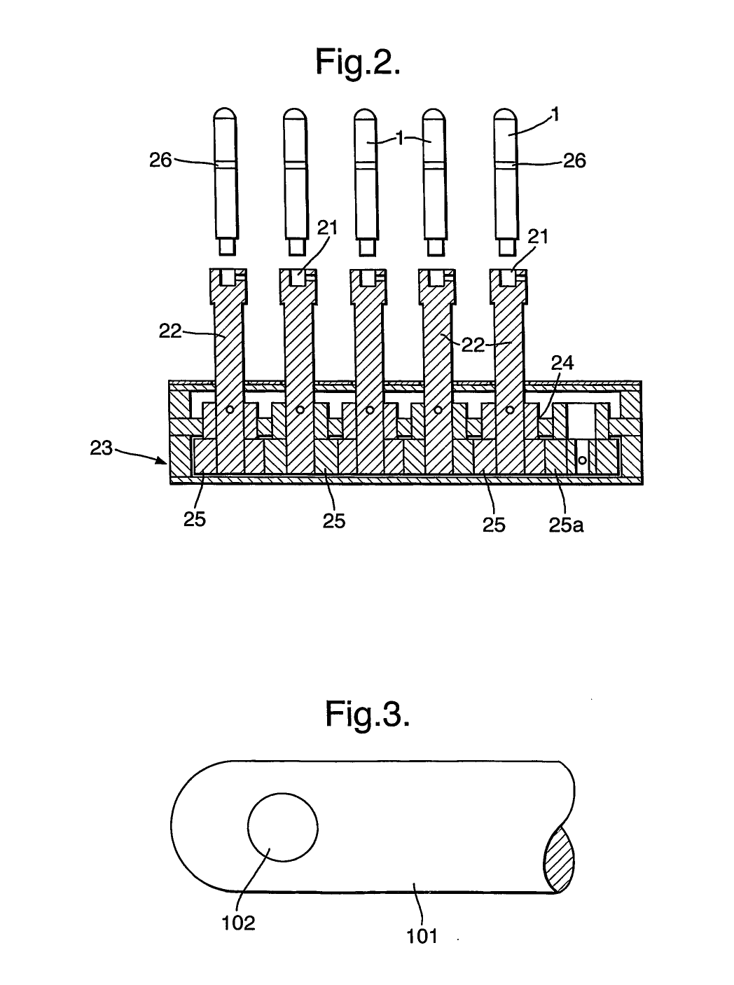

FIG. 2 is a schematic sectional side view of part of a modified form of apparatus; and

FIG. 3 is a side view of part of another modified form of apparatus.

Referring first to FIG. 1A, a substrate comprises the end portion of a solid steel rod 1 of circular cross-section.

The rod has a hemispherical end 2. A shield 3 in the form of a flat plate with a circular hole 4 is provided and is disposed with the end portion of the rod 1 projecting through the hole 4. Thus the shield 3 closely surrounds but is spaced from the rod 1.

A source 5 of charged powder material is provided alongside the end portion of the rod 1 at an even radial spacing from the rod. The source 5 has an elongate outlet 6, schematically illustrated in FIG. 1A, from which powder material is supplied.

The shield 3 has an electrically insulating base 7 and an electrically conducting layer 8 supported on the base 7.

A voltage source 9 is connected to apply a positive potential to the powder material source 5 and also to the electrically conducting layer 8 of the shield 3. As previously described, the potentials applied may comprise both DC bias potential and an AC potential. The rod 1 is earthed.

An infra red heater 10 is also provided alongside the rod 1.

In use after the rod has been coated with a suitable releasing agent the rod 1 is rotated by means not shown, as indicated by the arrow in FIG. 1A and positively charged powder is made available at the powder material source 5. The voltage source 9 establishes an electric field between the powder material source 5 and the rod 1 with the result that positively charged powder is driven onto the end portion of the rotating rod 1, including the hemispherical end 2 of the rod. The shield 3 shapes the electric field such that powder is deposited along the rod up to the shield 3 but not beyond and a well defined circumferential edge to the powder deposition is thereby defined. Application of powder is continued until powder ceases to transfer across from the source 5 to the rod 1 because the charged powder deposited on the rod 1 has so reduced the electric field between the powder source 5 and the rod.

Once the application of powder is complete, the infra red heater 10 is switched on to heat the powder material deposited on the rod 1 and convert it into a continuous layer. The material is then allowed to cool and is then removed from the rod, providing a hollow capsule shell.

FIG. 1B shows an alternative arrangement for the shield and the parts shown in FIG. 1B are referred by the same reference numerals as in FIG. 1A but with the suffix “b” added where the parts are arranged differently. Thus it will be seen that the shield 3b of FIG. 1B is of generally cylindrical shape surrounding the rod 1. The shield 3b has an outer electrically conducting cylindrical layer 8b and an inner electrically insulating cylindrical base 7b. In FIG. 1B the base 7b is shown slightly spaced from the rod 1 but it may be in contact with the rod 1 and indeed the shield 3b may be fixed to the rod 1 and rotates with the rod. Although not shown, it will be understood that the layer 8b is electrically connected to a voltage source 9 in the same manner as in the arrangement of FIG. 1A and the operation of the modified arrangement according to FIG. 1B is substantially the same as that of FIG. 1A.

As indicated above, the powder material source 5 may be of a kind known per se. For example, WO 02/49771 describes an apparatus that may be employed and shows in FIG. 1 a powder source having a roller 1a from which charged powder is supplied. FIG. 1C illustrates one possible orientation of the roller 1a of WO 02/49771 to the rod 1. In FIG. 1C the roller 1a of WO 02/49771 is shown without its associated apparatus and is referenced 11a. It will be seen that the axis of the roller 11a is perpendicular to the axis of the rod 1, that the periphery of the roller 11a is alongside the side of the rod 1 and that the rod 1 is rotated. It will be understood that the other parts of the apparatus (not shown in FIG. 1C) may be as shown in FIG. 1A or FIG. 1B. In operation powder leaves the region of the roller 11a adjacent to the side of rod 1 and is deposited along the exposed length of the rod 1.

FIG. 1D shows an alternative orientation of the roller 11a and the rod 1. In this case the axis of the roller 11a is perpendicular to the axis of the rod 1, but the periphery of the roller 11a is alongside the end of the rod 1. In this case the rod 1 need not be rotated. Powder from the roller 11a tends first to coat the adjacent end of the rod 1 but thereafter coats the more distant parts of the rod 1. Again it will be understood that the other parts of the apparatus (not shown in FIG. 1D) may be as shown in FIG. 1A or FIG. 1B; it will be understood that, if necessary, the shape and/or position of the heater 10 can be adjusted to avoid the heater and the roller 11a obstructing one another.

Whilst the apparatus shown is suitable for producing only one capsule shell at a time, it should be understood that by providing many rods and moving them and/or providing a plurality of sources of powder material and/or heaters, it is possible to adapt the apparatus to generate many capsule shells at a time.

FIG. 2 shows a rig that may be employed to coat a plurality of rods at one time. In the drawing five rods 1 are shown but it will be understood that a much greater number may be provided, if desired. Each rod 1 is detachably located in a socket 21 at one end of a mounting member 22. The other end of each mounting member 22 is received in a drive assembly 23 where it is rotatably mounted in a bearing block 24 and has a toothed gear portion 25. The toothed gear portion of adjacent mounting members mesh with one another and there is also provided an additional toothed gear portion 25a connected to a rotary drive (not shown). Thus, operation of the rotary drive causes rotation of each of the mounting members 22, with adjacent members rotating in opposite directions. It will be appreciated that one or more static or travelling powder sources, corresponding to the source 5 shown in FIG. 1 can be provided along the sides of the rods 1 as shown in FIG. 1C and a heater and/or shield can be provided as shown in FIG. 1A or 1B. A shield may be provided around each rod 1 in the region designated 26 in FIG. 2.

If desired, one or more additional rows of mounting members may be provided alongside the row shown in FIG. 2. If more than one additional row is provided then it is necessary either for the powder to be applied from the ends of the rods or for a sufficiently large space to be left between rows to accommodate an appropriate powder source.

FIG. 3 shows a special form of rod 101, which may be employed in any of the embodiments described above. The rod 101 is generally made of metal but in this particular case an insert 102 of electrically insulating material is provided, the top surface of the insert 102 being flush with the surface of the rod. The insert 102 may for example be formed by a nylon screw of, for example, 2 mm diameter screwed into a drilled and tapped hole in the rod 101. When the rod is coated with powder, there is a uniform coating over the rod except where the insert 102 is present, where there is no coating. In this way a capsule can be formed with a small aperture of a controlled size and at a predetermined location. Such capsules can be employed to enable or facilitate a range of drug delivery modes. For example, if the capsule shell is insoluble, drug in the capsule will be released only via the aperture resulting in a prolonged release profile.

It will be appreciated that by suitable choice of insert(s) the sizes(s), shape(s), position(s) and number of apertures can be altered.

In one particular example of the invention, using an apparatus of the kind shown schematically in FIG. 1C, coating was carried out under the following conditions:

| | | |
|---|---|---|
| Speed of rotation of rod 1: | 35 | rpm |
| Gap between rod 1 and roller 11a (minimum): | 10 | mm |
| Potential of roller 11a: | −3000 | V |
| Coating time: | 90 | seconds |

In another particular example of the invention, again using an apparatus of the kind shown schematically in FIG. 1C, coating was carried out under the following conditions:

| | | |
|---|---|---|
| Speed of rotation of rod 1: | 35 | rpm |
| Gap between rod 1 and roller 11a (minimum): | 2 | mm |
| Potential of roller 11a: | −1000 | V |
| Coating time: | 90 | seconds |

In each case the rod 1 was maintained at earth potential and after application to the rod 1, the coating was exposed to a fuser at a temperature of 250° C. for a time of 180 seconds.

Capsules produced in these examples had wall thicknesses of 150-200 mm and a length in the range of 10 to 30 mm.

1. A method for the production of a capsule shell, wherein the capsule shell is prepared by electrostatic powder deposition on a substrate.

2. A method for the production of capsule shells, which comprises electrostatically applying a powder coating material to a plurality of shaped substrates, treating the powder to form a continuous coating layer on each of the shaped substrates, and removing the shaped coating layers from the substrate to provide hollow capsule shells.

3. A method as claimed in claim 1, wherein the substrate(s) is pretreated with a releasing agent.

4. A method as claimed in claim 3, wherein the releasing agent is talc.

5. A method as claimed in claim 1, wherein the substrate(s) is a metal substrate.

6. A method as claimed in claim 5, wherein the substrate(s) is a steel substrate.

7. A method as claimed in claim 1, wherein after application the powder is heated to form a coherent coating layer.

8. A method as claimed in claim 1, wherein the powder material comprises an acrylic polymer, a polyvinylpyrrolidone-vinyl acetate copolymer or a hydroxypropylcellulose.

9. A method as claimed in claim 8, wherein the powder material comprises an ammoniomethacrylate copolymer.

10. A method as claimed in claim 8, wherein the powder material comprises hydroxypropyl methylcellulose acetate succinate.

11. A method as claimed in claim 1, wherein the powder material is a phthalate derivative.

12. A method as claimed in claim 1, wherein the powder material includes 5 to 20% of plasticizer.

13. A method as claimed in claim 1 for the production of a pharmaceutical capsule shell or shells, the powder material being pharmaceutically suitable.

14. A method as claimed in claim 1, wherein the powder material is applied from a source spaced from the substrate by a distance in the range of 0.5 mm to 5 mm.

15. A method as claimed in claim 1, including the steps of:—
applying a bias voltage to generate an electric field between a source of the powder material and the substrate;
applying the electrostatically charged powder material to the substrate, the powder material being driven onto the substrate by the interaction of the electric field with the charge powder material and the presence of the charged powder material on the substrate serving to build up an electric charge on the substrate and thereby reduce the electric field generated by the bias voltage between the source of powder material and the substrate, and
continuing the application of the electrostatically charged powder material to the substrate until the electric field between the source of powder material and the substrate is so small that the driving of the powder material by the electric field onto the substrate is substantially terminated.

16. A method as claimed in claim 1, wherein an electrically conducting shield is provided around part or all of the substrate.

17. A method as claimed in claim 16, wherein the substrate is in the shape of a rod and the electrically conducting shield is disposed closely around, but spaced from, the rod.

18. A method as claimed in claim 17, wherein the shield is spaced from the rod by a distance of less than 3 mm.

19. A method as claimed in claim 1, in which the surface of the substrate on which the powder is deposited is formed generally of an electrically conducting material but includes at least one region formed of a material of reduced electrical conductivity.

20. A method as claimed in claim 19, in which the material of reduced electrical conductivity is an electrically insulating material.

21. A method as claimed in claim 19, in which there is substantially no powder deposition on the material of reduced electrical conductivity.

22. A method as claimed in any one of claims 1, in which the capsule shell is formed with at least one aperture.

23. A method for the production of a capsule, wherein a capsule shell prepared by a process as claimed in claim 1 is filled and capped to provide an assembled capsule.

24. A method as claimed in claim 23, wherein the cap is a shell prepared by electrostatic powder deposition on a substrate.

25. A method for the preparation of capsules, which comprises electrostatically applying a powder coating material to a plurality of shaped substrates, treating the powder to form a continuous coating layer on each of the shaped substrates, and removing the shaped coating layers from the substrate to provide hollow capsule shells, constituting capsule bodies and capsules caps and filling the capsule bodies and assembling capsules from the filled capsule bodies and the capsule caps.

26. A method as claimed in any one of claims 23, wherein the capsule(s) is filled with a pharmaceutical and the capsule material is pharmaceutically suitable.

27. An apparatus for the production of a capsule shell, the apparatus including a substrate, a source of charged powder material and a voltage source for applying a bias voltage between the source of powder material and the substrate to generate an electric field therebetween such that powder material is applied to the substrate.

28. An apparatus as claimed in claim 27, including a plurality of substrates, in the form of a plurality of rotatable rods, the rods being arranged to be rotated by a common drive arrangement.

29. A method of coating a substrate by electrostatic powder deposition on the substrate, in which the surface of the substrate on which the powder is deposited is formed generally of an electrically conducting material but includes at least one region formed of a material of reduced electrical conductivity.

30. A method as claimed in claim 29, in which the material of reduced electrical conductivity is an electrically insulating material.

31. A method as claimed in claim 29, in which there is substantially no powder deposition on the material of reduced electrical conductivity.

32. A method as claimed in claims 29, in which the coating is formed with at least one aperture.
